(19) United States
(12) Patent Application Publication
(10) Pub. No.: US 2020/0205160 A1
(43) Pub. Date: Jun. 25, 2020

(54) APPARATUS AND METHOD FOR COORDINATING INTER-CELL INTERFERENCE AND NON-VOLATILE COMPUTER READABLE MEDIA THEREOF

(71) Applicant: Industrial Technology Research Institute, Hsinchu (TW)

(72) Inventors: Shu-Chieh CHANG, Hsinchu City (TW); Chai-Hien GAN, Hsinchu City (TW)

(21) Appl. No.: 16/231,822

(22) Filed: Dec. 24, 2018

(51) Int. Cl. H04W 72/08; H04W 76/10

(52) U.S. Cl. CPC H04W 72/082; H04W 84/045; H04W 76/10

(57) ABSTRACT

An apparatus for coordinating inter-cell interference is provided. The apparatus includes a processor and a transceiver. The processor operates a first virtual cell and a second virtual cell to simulate a victim cell and an aggressor cell respectively. The processor controls the transceiver to establish a link between each of at least one macro cell and the first virtual cell each through a first interface, and to establish a link between each macro cell and the second virtual cell each through a second interface. The processor operates a coordinator to receive a first ABS pattern provided by each macro cell to reduce interference on at least one pico cell that interfering by each macro cell and reduce interference on each macro cell that interfering by at least one femto cell.

### TECHNICAL FIELD

The disclosure generally relates to an apparatus, method, and non-volatile computer readable media for coordinating inter-cell interference.

### BACKGROUND

In a heterogeneous network environment, an Enhanced Inter Cell Interference Coordination (eICIC) structure is provided in 3 l GPP standard in order to avoid inter-cell interference. In the eICIC structure, the almost blank subframe (ABS) mechanism is one scheme to reduce inter-cell interference. In the ABS mechanism, there are two roles; aggressor cell and victim cell. The aggressor cell may select a partial sub-frame to reduce power or not perform data transmission. As a result, the victim cell can use the selected sub-frame to provide service to the interfered-with user. For example, when the user of a pico cell experiences interference from a macro cell, the macro cell may send the ABS pattern to tell the pico cell which subframe the pico cell can use to provide service to the user experiencing interference from the macro cell. Or, when the user of a macro cell experiences interference from a femto cell, the femto cell may send the ABS pattern to tell the macro cell which subframe the macro cell can use to provide service to the user experiencing interference from the femto cell.

In addition, as the development of the Ultra-Dense Networks (UDN) technology, the deployment density of the base stations (or cells) is higher and higher. Therefore, a centralized coordination mechanism is provided to assign the ABS patterns according to the current network status. In the centralized coordination mechanism, a gateway is configured for assigning the ABS patterns to coordinate interference between the base stations (or cells).

However, in a centralized coordination mechanism, a single coordinator (e.g. a gateway) can only assign ABS patterns based on a macro cell being an aggressor cell or a macro cell being a victim cell. In other words, when a macro cell has two roles (aggressor cell and victim cell), assigning the ABS patterns based on the macro cells roles will be a challenge.

### BRIEF SUMMARY

An interference coordinating apparatus, a method for coordinating inter-cell interference and a non-volatile computer-readable media are provided to overcome the problems described above.

An embodiment in accordance with the disclosure provides an interference coordinating apparatus. The interference coordinating apparatus comprises a processor and a transceiver. The processor operates a first virtual cell to simulate a victim cell, and operates a second virtual cell to simulate an aggressor cell. The transceiver is coupled to the processor. The processor controls the transceiver to establish a link between at least one macro cell and the first virtual cell through a first interface each corresponding to each of the at least one macro cell, and establish a link between the macro cell and the second virtual cell through a second interface each corresponding to each of the at least one macro cell to receive and transmit data. The processor operates a coordinator to receive a first ABS pattern provided by each macro cell to reduce interference on at least one pico cell that interfering by each macro cell and reduce interference on each macro cell that interfering by at least one femto cell.

An embodiment in accordance with the disclosure provides a method for coordinating inter-cell interference. The method is applied to an interference coordinating apparatus. The method comprises the steps of establishing a link between at least one macro cell and a first virtual cell of the interference coordinating apparatus through a first interface each corresponding to each of the at least one macro cell, wherein the first virtual cell is configured to simulate a victim cell; establishing a link between the macro cell and a second virtual cell of the interference coordinating apparatus through a second interface each corresponding to each of the at least one macro cell to receive and transmit data, wherein the second virtual cell is configured to simulate an aggressor cell; and operating a coordinator of the interference coordinating apparatus to receive a first ABS pattern provided by each macro cell to reduce interference on at least one pico cell that interfering by each macro cell and reduce interference on each macro cell that interfering by at least one femto cell.

An embodiment in accordance with the disclosure provides non-volatile computer-readable media storing a computer program product. The computer program product is configured to perform steps of establishing a link between at least one macro cell and a first virtual cell of the interference coordinating apparatus through a first interface each corresponding to each of the at least one macro cell, wherein the first virtual cell is configured to simulate a victim cell; establishing a link between the macro cell and a second virtual cell of the interference coordinating apparatus through a second interface each corresponding to each of the at least one macro cell to receive and transmit data, wherein the second virtual cell is configured to simulate an aggressor cell; and operating a coordinator of the interference coordinating apparatus to receive a first ABS pattern provided by each macro cell to reduce interference on at least one pico cell that interfering by each macro cell and reduce interference on each macro cell that interfering by at least one femto cell.

### BRIEF DESCRIPTION OF THE DRAWINGS

The disclosure will become more fully understood by referring to the following detailed description with reference to the accompanying drawings, wherein:

FIG. 1 is a block diagram of an interference coordinating apparatus 100 according to an embodiment of the disclosure;

FIG. 2 is a flowchart illustrating of establishing the link between a first virtual cell and a macro cell and the link between a second virtual cell and the macro cell according to an embodiment of the disclosure;

FIG. 3 is a flowchart illustrating for the interference coordinating apparatus 100 assigning the ABS patterns according to an embodiment of the disclosure;

FIGS. 4A-4C are schematic diagrams of assigning ABS patterns according to an embodiment of the disclosure;

FIGS. 5A-5C are schematic diagrams of assigning ABS patterns according to another embodiment of the disclosure; and

FIG. 6 is a flowchart illustrating a method for coordinating inter-cell interference according to an embodiment of the disclosure.

### DESCRIPTION OF THE EMBODIMENTS

The descriptions of the disclosure are some embodiments for the purpose of illustrating the general principles of the disclosure and should not be configured to limit the disclosure. The scope of the invention is determined by reference to the appended claims.

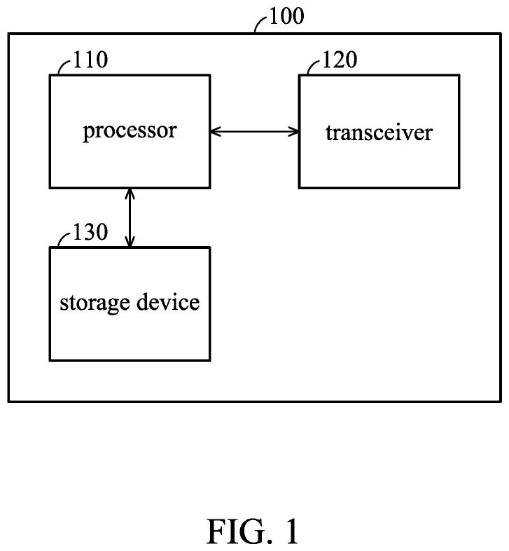

FIG. 1 is a block diagram of an interference coordinating apparatus 100 according to an embodiment of the disclosure. According to an embodiment of the invention, the interference coordinating apparatus 100 may be a gateway or a server, but the disclosure should not be limited thereto. As shown in FIG. 1, the interference coordinating apparatus 100 may comprise a processor 110, a transceiver 120, and a storage device 130. The processor 110 is coupled to the transceiver 120 and the storage device 130. It should be noted that FIG. 1 presents a simplified block diagram in which only the elements relevant to the disclosure are shown. However, the disclosure is not limited to what is shown in FIG. 1.

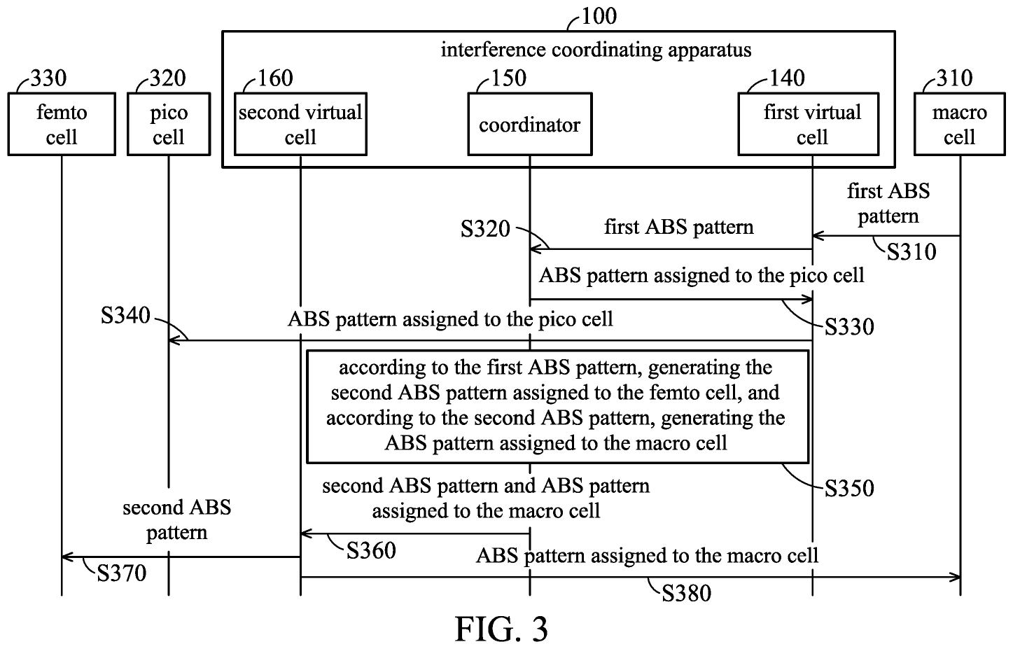

According to an embodiment of the disclosure, the processor 110 may be configured to perform the data stored in the storage device 130 to operate a first virtual cell 140 (as shown in FIG. 3) to simulate a victim cell, and to operate a second virtual cell 160 (as shown in FIG. 3) to simulate an aggressor cell. In addition, the processor 110 may be configured to perform the data stored in the storage device 130 to operate a coordinator 150 (as shown in FIG. 3) to coordinate the assignment for the almost blank subframe (ABS) to reduce the inter-cell interference.

According to an embodiment of the disclosure, the transceiver 120 may be a network card or a network chip, but the disclosure should not be limited thereto. The processor 110 may control the transceiver 120 to establish a link between at least one macro cell and the first virtual cell 140 of the interference coordinating apparatus 100 through a first interface (i.e. each link between one macro cell and the first virtual cell 140 may use one respective corresponding first interface), and establish a link between at least one macro cell and the second virtual cell 160 of the interference coordinating apparatus 100 through a second interface (i.e. each link between one macro cell and the second virtual cell 160 may use one respective corresponding second interface) to transmit and receive data through the links. When the macro cell links with the first virtual cell 140, the macro cell can be regarded as an aggressor cell (i.e. the first virtual cell 140 is regarded as a victim cell), and when the macro cell links with the first virtual cell 160, the macro cell can be regarded as a victim cell (i.e. the second virtual cell 160 is regarded as an aggressor cell).

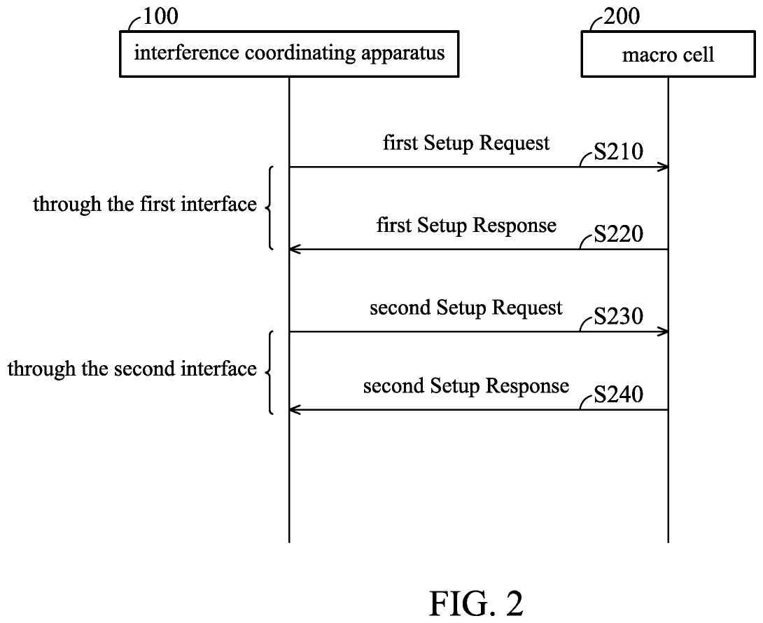

FIG. 2 is a flowchart illustrating of establishing the link between a first virtual cell and a macro cell and the link between a second virtual cell and the macro cell according to an embodiment of the disclosure. As shown in FIG. 2, while the first virtual cell 140 of the interference coordinating apparatus 100 needs to establish a link with a macro cell 200, the transceiver 120 of the interference coordinating apparatus 100 may transmit a first Setup Request to the macro cell 200 through a first interface (S210). The macro cell 200 may respond a first Setup Response to the interference coordinating apparatus 100 through the first interface to establish the link with the first virtual cell 140 (S220). In the embodiment, the first Setup Request may comprise a cell identification (ID), wherein the cell ID may be an HeNB ID or an eNB ID. The HeNB ID or eNB ID may be a dedicated ID for the interference coordinating apparatus 100, or the ID used by another cell in the network. The first Setup Response may comprise the cell ID of the macro cell 200. In addition, as shown in FIG. 2, while the second virtual cell 160 of the interference coordinating apparatus 100 needs to establish a link with a macro cell 200, the transceiver 120 of the interference coordinating apparatus 100 may transmit a second Setup Request to the macro cell 200 through a second interface (S230). The macro cell 200 may respond a second Setup Response to the interference coordinating apparatus 100 through the second interface to establish the link with the second virtual cell 160 (S240). In the embodiment, the second Setup Request comprises the HeNB ID of a femto cell which interferes with the macro cell 200, and the Subscribe Group ID (CSG ID), and the second Setup Response may comprise the cell ID of the macro cell 200. According to an embodiment of the disclosure, the first interface and the second interface may be X2 interface or Xn interface. Each macro cell may link with the first virtual cell 140 through one corresponding first interface, and each macro cell may link with the second virtual cell 160 through one corresponding second interface.

In addition, the processor 110 may control the transceiver 120 to establish a link between at least one pico cell (which may experience interference from a macro cell) and the first virtual cell 140 of the interference coordinating apparatus 100 through a third interface (i.e. each link between one pico cell and the first virtual cell 140 may use one respective corresponding third interface) to transmit and receive data, wherein a link between other pico cells (those being interfered with by another macro cell) and the first virtual cell 140 also may be established. The transceiver 120 may transmit a Setup Request to the pico cell, wherein the Setup Request may comprise a cell ID, and the cell ID may be an HeNB ID or eNB ID. In addition, the processor 110 control the transceiver 120 to establish a link between at least one femto cell (wherein each femto cell may interfere with at least one macro cell) and the second virtual cell 160 of the interference coordinating apparatus 100 through a fourth interface (i.e. each link between one femto cell and the second virtual cell 160 may use one respective corresponding fourth interface) to transmit and receive data. According to an embodiment of the disclosure, the third interface may be X2 interface or Xn interface, and each pico cell may link with the first virtual cell 140 through one corresponding third interface. According to an embodiment of the disclosure, the fourth interface may be X2 interface, Xn interface or Operations and Management (OAM) interface (e.g. TR-069 interface), and each femto cell may link with the second virtual cell 160 through one corresponding fourth interface.

According to the embodiments of the disclosure, the storage device 130 may be configured to store software and firmware codes, system data, and so on. The storage device 130 may be a volatile memory such as a Random Access Memory (RAM); a non-volatile memory such as a flash memory or Read-Only Memory (ROM); a hard disk; or any combination thereof, but the disclosure is not limited to these.

FIG. 3 is a flowchart illustrating for the interference coordinating apparatus 100 assigning the ABS patterns according to an embodiment of the disclosure. Referring to FIG. 1 and FIG. 3, FIG. 3 shows the flowchart for the interference coordinating apparatus 100 of FIG. 1 operating the first virtual cell 140, coordinator 150 and the second virtual cell 160 to assign the ABS patterns. After the macro cell 310 transmits the first ABS pattern provided by itself to the first virtual cell 140 of the interference coordinating apparatus 100 through the first interface (step S310), the first virtual cell 140 may transmit the first ABS pattern to the coordinator 150 (step S320). The coordinator 150 may generate the ABS pattern assigned to the pico cell 320 (that interfering by the macro cell 310) according to the first ABS pattern, and transmit the ABS pattern assigned to the pico cell 320 (that interfering by the macro cell 310) to the first virtual cell 140 (step S330). Then, the first virtual cell 140 may transmit the ABS pattern assigned to the pico cell 320 (that interfering by the macro cell 310) to the pico cell 320 through the third interface (step S340). In step S350, according to the first ABS pattern, the coordinator 150 may generate the second ABS pattern assigned to the femto cell 330 (which interferes with the macro cell) to reduce interference on the macro cell 310. In step S350, according to the second ABS pattern assigned to the femto cell 330, the coordinator 150 may further generate the ABS pattern assigned to the macro cell 310. The coordinator 150 may transmit the second ABS pattern assigned to the femto cell 330 (which interferes with the macro cell) and the ABS pattern assigned to the macro cell 310 to the second virtual cell 160 (step S360). Then, the second virtual cell 160 may transmit the second ABS pattern to the femto cell 330 through the fourth interface and transmit the ABS pattern assigned to the macro cell 310 to the macro cell 310 through the second interface.

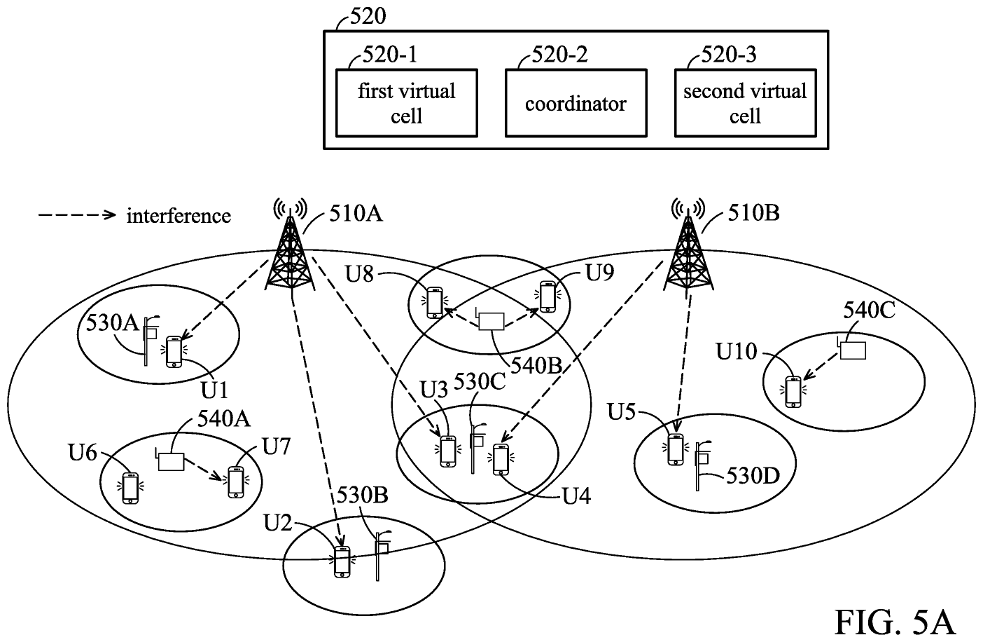

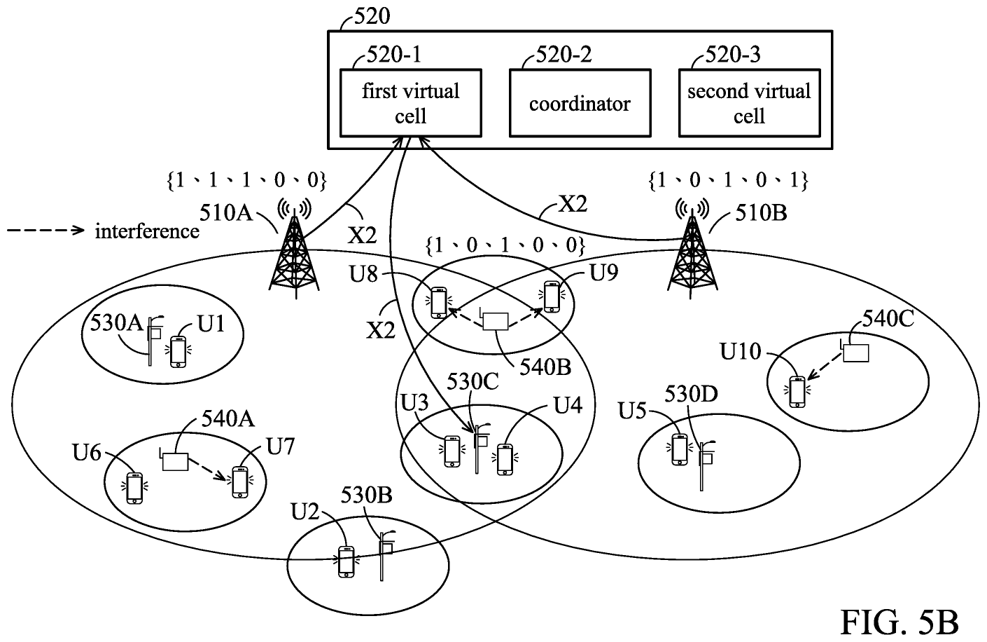

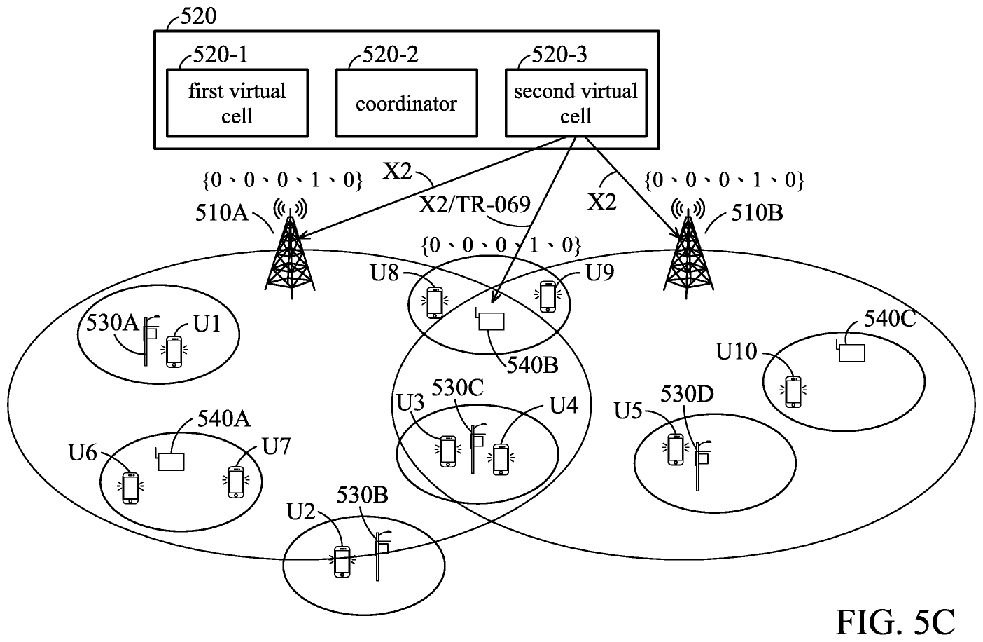

Specifically, FIG.3 only shows a macro cell 310, a pico cell 320 and a femto cell 330, but the disclosure should not be limited thereto. The flowchart of FIG. 3 also can be applied to a plurality of macro cells, a plurality of pico cells, and a plurality of femto cells. FIGS. 5A-5C are used as examples below.

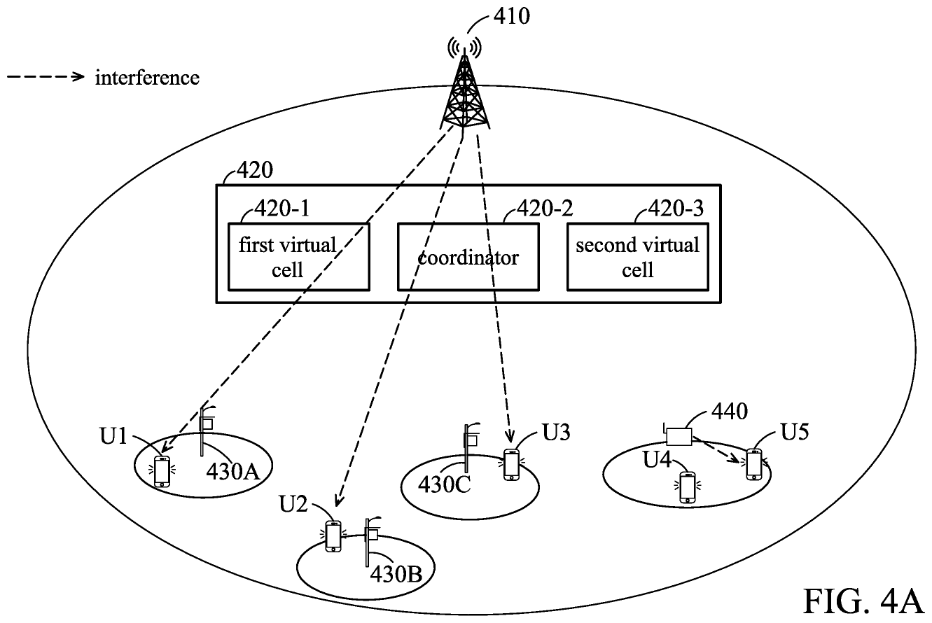

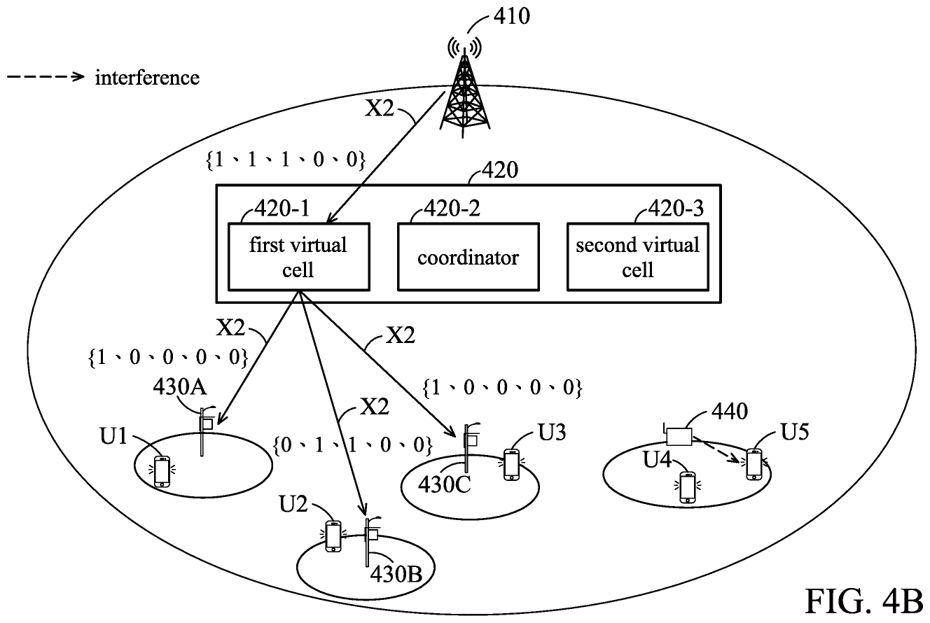

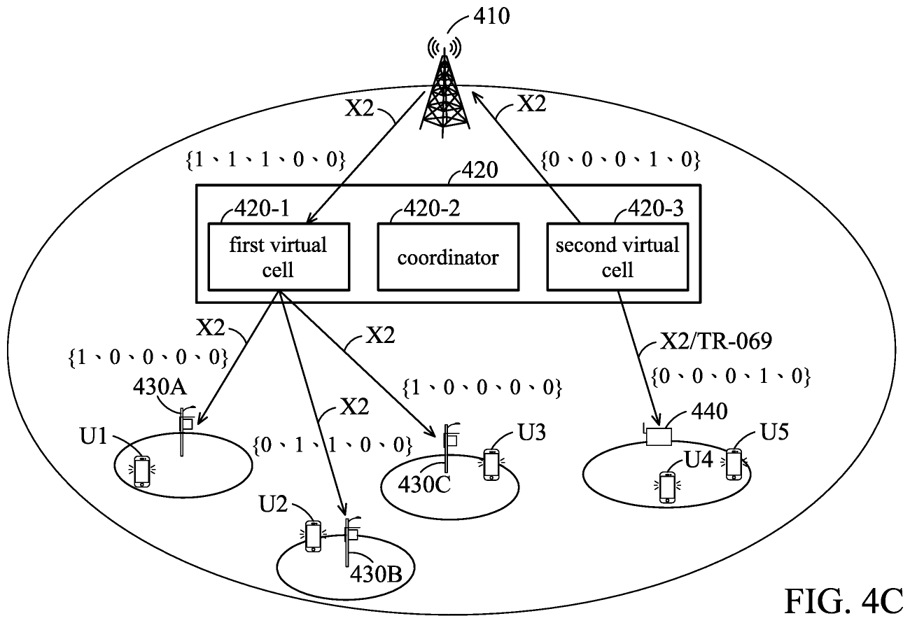

FIGS. 4A-4C are schematic diagrams of assigning ABS patterns according to an embodiment of the disclosure. It should be noted that the schematic diagrams of FIGS. 4A-4C are used to illustrate the embodiments of the disclosure, but the disclosure should not be limited thereto.

Referring to FIG. 4A, the users U1, U2 and U3 of pico cells 430A-430C are interfered with by the macro cell 410 (i.e. in this situation, the macro cell 410 is an aggressor cell), and the user U5 of macro cell 410 experiences interference from the femto cell 440 (i.e. in this situation, the macro cell 410 is a victim cell). In addition, the U4 is the user of a femto cell 440.

As shown in FIG. 4B, in an embodiment of the disclosure, when the users U1, U2 and U3 of pico cells 430A-430C are interfered with by the macro cell 410, the pico cells 430A-430C tell the interference coordinating apparatus 420 that they are being interfered with by the macro cell 410 through the third interface (e.g. X2 interface). After the macro cell 410 knows that the pico cells 430A-430C are being interfered with, from the interference coordinating apparatus 420, the macro cell 410 may generate a first ABS pattern (e.g. {1-1-1-0-0}, wherein “1” in the ABS pattern means the time which can be assigned to the pico cells 430A-430C, and “0” in the ABS pattern means the time which cannot be assigned to the pico cells 430A-430C), and the macro cell 410 may transmit the first ABS pattern to the first virtual cell 420-1 of the interference coordinating apparatus 420 through the first interface (e.g. X2 interface). The first virtual cell 420-1 may transmit the first ABS pattern provided by the macro cell 410 to the coordinator 420-2 of the interference coordinating apparatus 420, and according to the first ABS pattern, the coordinator 420-2 may generate the ABS patterns respectively assigned to each of the pico cells 430A-430C. Finally, the first virtual cell 420-1 may transmit the ABS patterns respectively assigned to each of the pico cells 430A-430C to the pico cells 430A-430C through the third interface (e.g. X2 interface). For example, if the first ABS pattern generated by the macro cell 410 is {1-1-1-0-0}, it means that the ABS patterns respectively assigned to each of the pico cells 430A-430C may be one of the ABS patterns {1-0-0-0-0}, {0-1-0-0-0}, {1-1-0-0-0}, {0-1-1-0-0}, {1-0-1-0-0}, and {1-1-1-0-0}. Therefore, the coordinator 420-2 may determine the ABS patterns respectively assigned to each of the pico cells 430A-430C from the six types of ABS patterns (i.e. {1-0-0-0-0}, {0-1-0-0-0}, {1-1-0-0-0}, {0-1-1-0-0}, {1-0-1-0-0}, and {1-1-1-0-0}), wherein each pico cell may be assigned the same or different ABS pattern. As shown in FIG. 4B, the ABS pattern assigned to the pico cells 430A and 430C is {1-0-0-0-0} and the ABS pattern assigned to the pico cells 430B is {0-1-1-0-0}.

As shown in FIG. 4C, in another embodiment, when the macro cell 410 experiences interference from the femto cell 440, in order to avoid the second ABS pattern of femto cell 440 conflicts with the first ABS pattern of the macro cell 410, the coordinator 420-2 may ask the first virtual cell 420-1 for providing the first ABS pattern generated by the macro cell 410, and perform a complementary calculation to get the complementary set corresponding to the first ABS pattern. For example, if the first ABS pattern generated by the macro cell 410 is {1-1-1-0-0}, after the complementary calculation, the first ABS pattern may be transferred into the ABS pattern {0-0-0-1-1}, i.e. it means that the second ABS pattern assigned to femto cell 440 may be one of the ABS patterns {0-0-0-1-0}, {0-0-0-0-1}, and {0-0-0-1-1}, wherein“1” in the ABS pattern means the time which can be assigned to the macro cell 410, and “0” in the ABS pattern means the time which cannot be assigned to the macro cell 410. When the coordinator 420-2 determines the second ABS pattern (e.g. {0-0-0-1-0}) assigned to the femto cell 440, the coordinator 420-2 may transmit the second ABS pattern and the ABS pattern assigned to the macro cell 410 to the second virtual cell 420-3, wherein the ABS pattern assigned to the macro cell 410 is generated according to the second ABS pattern. Then, the second virtual cell 420-3 may transmit the second ABS pattern to the femto cell 440 through the fourth interface (e.g. X2 interface or TR-069 interface), and transmit the ABS pattern assigned to the macro cell 410 to the macro cell 410 through the second interface (e.g. X2 interface).

FIGS. 5A-5C are schematic diagrams of assigning ABS patterns according to another embodiment of the disclosure. It should be noted that the schematic diagrams of FIGS. 5A-5C are used to illustrate the embodiments of the disclosure, but the disclosure should not be limited thereto.

Referring to FIG. 5A, the users U1 and U2 of pico cells 530A and 530C are interfered with by the macro cell 510A, the user U5 of the pico cell 530D experiences interference from the macro cell 510B, and the users U3 and U4 of pico cell 530C are interfered with by the macro cell 510A and the macro cell 510B. In addition, the user U7 of the macro cell 510A experiences interference from the femto cell 540A, the user U10 experiences interference from the femto cell 540C, and the user U8 of the macro cell 510A and the user U9 of the macro cell 510B are interfered with by the femto cell 540C. In addition, the U6 is the user of femto cell 540A.

In FIG. 5A, the operations of the coordinator 520 assigning the ABS patterns to the pico cells 530A, 530B and 530D, and assigning the ABS patterns to the femto cells 540A and 540C are similar to the operations of the coordinator 420. Therefore, no more discussion is illustrated. In the embodiment, the following descriptions will focus on how does the coordinator 520 assign the ABS patterns to the pico cell 530C that interfering by the macro cell 510A and the macro cell 510B at the same time and how does the coordinator 520 assign the ABS patterns to the femto cell 540B which interferes with the macro cell 510A and the macro cell 510B at the same time.

As shown in FIG. 5B, after the macro cell 510A knows that the pico cells 530A-530C are being interfered with, from the interference coordinating apparatus 520, the macro cell 510A may generate a first ABS pattern (e.g. {1-1-1-0-0}, wherein “1” in the ABS pattern means the time which can be assigned to the pico cells 530A-530C, and “0” in the ABS pattern means the time which cannot be assigned to the pico cells 530A-530C), and after the macro cell 510B knows that the pico cells 530C-530D are being interfered with, from the interference coordinating apparatus 520, the macro cell 510B may generate another first ABS pattern (e.g. {1-0-1-0-1}. The macro cell 510A and the macro cell 510 B may respectively transmit its first ABS patterns to the first virtual cell 520-1 of the interference coordinating apparatus 520 through its corresponding first interface (e.g. X2 interface). The first virtual cell 520-1 may transmit the first ABS patterns provided by the macro cell 510A and macro cell 510B to the coordinator 520-2 of the interference coordinating apparatus 520.

In the embodiment, because the pico cell 530C experiences interference from the macro cell 510A and the macro cell 510B at the same time, the coordinator 520-2 may perform the intersection calculation on the first ABS patterns generated by each of the macro cell 510A and the macro cell 510B. When the first ABS pattern of the macro cell 510A and the first ABS pattern of the macro cell 510B have a calculated intersection, the coordinator 520-2 may determine the ABS pattern assigned to the pico cell 530C according to the calculated intersection. Then, the first virtual cell 520-1 may transmit the ABS pattern assigned to the pico cell 530C to the pico cell 530C through the third interface (e.g. X2 interface). For example, if the first ABS pattern generated by the macro cell 510A is {1-1-1-0-0} and the first ABS pattern generated by the macro cell 510B is {1-0-1-0-1}, when the coordinator 520-2 performs the intersection calculation on the first ABS patterns generated by each of the macro cell 510A and the macro cell 510B, the coordinator 520-2 may generate a ABS pattern {1-0-1-0-0} (the result of the intersection calculation). The ABS pattern {1-0-1-0-0} means that the ABS pattern assigned to the pico cell 530C can be one of the ABS patterns {1-0-0-0-0}, {0-0-1-0-0} and {1-0-1-0-0}. Therefore, the coordinator 520-2 may determine the ABS pattern assigned to the pico cell 530C from the three types of ABS patterns (i.e. {1-0-0-0-0}, {0-0-1-0-0} and {1-0-1-0-0}).

In another embodiment of the disclosure, when the first ABS pattern of the macro cell 510A and the first ABS pattern of the macro cell 510B do not have a calculated intersection, according to the interference strength of the macro cell 510A and the interference strength of the macro cell 510B, the coordinator 520-2 may determine to select the first ABS pattern of the macro cell 510A or the first ABS pattern of the macro cell 510B to generate the ABS pattern assigned to the pico cell 530C. For example, if the interference strength of the macro cell 510A is greater than the interference strength of the macro cell 510B (i.e. the interference of the macro cell 510A for the pico cell 530C is greater than the interference of the macro cell 510B for the pico cell 530C), the coordinator 520-2 may generate the ABS pattern assigned to the pico cell 530C according to the first ABS pattern of the macro cell 510A.

As shown in FIG. 5C, when the users of the macro cell 510A and the macro cell 510B are interfered with by the femto cell 540B, in order to avoid the second ABS pattern of the femto cell 540 conflicts with the first ABS pattern of the macro cell 510A and the first ABS pattern of the macro cell 510B, the coordinator 520-2 may ask the first virtual cell 520-1 for providing the first ABS pattern generated the macro cell 510A and the first ABS pattern generated by the macro cell 510B, and perform a union calculation on the first ABS pattern of the macro cell 510A and the first ABS pattern of the macro cell 510B to get the union set corresponding to the first ABS pattern of the macro cell 510A and the first ABS pattern of the macro cell 510B. Then, the coordinator 520-2 may perform a complementary calculation on the union calculation result to generate the second ABS pattern assigned to the femto cell 540.

For example, if the first pattern generated by the macro cell 510A is {1-1-1-0-0} and the first pattern generated by the macro cell 510B is {1-0-1-0-1}, after the union calculation, the first ABS patterns may be transferred into the ABS pattern {1-1-1-0-1}. Then, after the complementary calculation the ABS pattern {1-1-1-0-1} may be transferred into the ABS pattern {0-0-0-1-0}, wherein “1” in the ABS pattern means the time which can be assigned to the macro cell 510A and macro cell 510B, and “0” in the ABS pattern means the time which cannot be assigned to macro cell 510A and macro cell 510B. In another example, if the first pattern generated by the macro cell 510A is {1-0-1-0-0} and the first pattern generated by the macro cell 510B is {1-0-1-0-1}, after the union calculation, the first ABS patterns may be transferred into the ABS pattern {1-0-1-0-1}. Then, after the complementary calculation, the ABS pattern {1-0-1-0-1} may be transferred into the ABS pattern {0-1-0-1-0}. The ABS pattern {0-1-0-1-0} means that the second ABS pattern assigned to the femto cell 540B can be one of the ABS patterns {0-1-0-0-0}, {0-0-0-1-0} and {0-1-0-1-0}. After the coordinator 520-2 determines the second ABS pattern assigned to the femto cell 540B (e.g. {0-0-0-1-0}), and according to the second ABS pattern assigned to the femto cell 540B, generates the ABS patterns assigned to the macro cell 510A and the macro cell 510B (the ABS pattern assigned to the macro cell 510A and the ABS pattern assigned to the macro cell 510B could be the same or could be different), the coordinator 520-2 may transmit the second ABS pattern and the ABS patterns assigned to the macro cell 510A and the macro cell 510B to the second virtual cell 520-3. Then, the second virtual cell 520-3 may transmit the second ABS pattern to the femto cell 540B through the fourth interface (X2 interface or TR-069 interface), and respectively transmit the ABS pattern assigned to the macro cell 510A and the ABS pattern assigned to the macro cell 510B to the macro cell 510A and the macro cell 510B through each of the second interfaces (e.g. X2 interface).

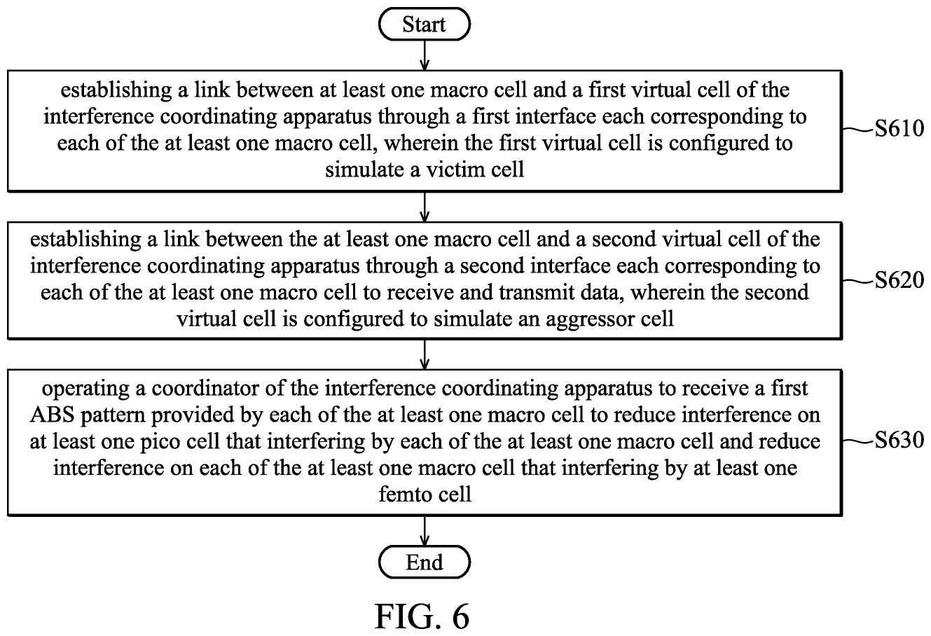

FIG. 6 is a flowchart illustrating a method for coordinating inter-cell interference according to an embodiment of the disclosure. The method for coordinating inter-cell interference can be applied to the interference coordinating apparatus 100 of the disclosure. In step S610, the interference coordinating apparatus 100 establishes links between at least one macro cell and a first virtual cell of the interference coordinating apparatus 100 through each first interface corresponding to each macro cell to transmit and receive data, wherein the first virtual cell is configured to simulate a victim cell. In step S620, the interference coordinating apparatus 100 establishes links between at least one macro cell and a second virtual cell of the interference coordinating apparatus 100 through each second interface corresponding to each macro cell to transmit and receive data, wherein the second virtual cell is configured to simulate an aggressor cell. In step S630, the coordinator of the interference coordinating apparatus 100 receives the first ABS patterns provided by at least one macro cell from the first virtual cell to reduce interference on any pico cells that interfering by each macro cell, and to reduce interference on any macro cells that interfering by at least one femto cell.

Besides reducing the interference on the pico cells in the cover range of each macro cell, according to the embodiments of the disclosure, when a pico cell experiences interference from a plurality of macro cells, the interference on the pico cell in the overlap cover range of the macro cells also can be reduced.

In some embodiments, the method for coordinating inter-cell interference further comprises that, according to the first ABS patterns provided by at least one macro cell, the interference coordinating apparatus 100 generates a second ABS pattern of each of at least one femto cell to reduce interference on each macro cell that interfering by the at least one femto cell.

In some embodiments, the method for coordinating inter-cell interference further comprises that the interference coordinating apparatus 100 establishes the links between at least one pico cell and the first virtual cell through each third interface corresponding to each pico cell to receive and transmit data. According to the first ABS patterns provided by at least one macro cell, the interference coordinating apparatus 100 may use the coordinator to generate the ABS patterns assigned to at least one pico cell, which the macro cell is interfering with. Then, the interference coordinating apparatus 100 may use the first virtual cell to transmit the ABS patterns assigned to at least one pico cell through the third interface each corresponding to each of the at least one pico cell.

In some embodiments, the method for coordinating inter-cell interference further comprises that, when one of the at least one pico cell experiences interference from a plurality of macro cells, the interference coordinating apparatus 100 may use the coordinator to perform an intersection calculation on the first ABS patterns provided by the plurality of macro cells, and when the first ABS patterns have a calculated intersection, according to result of the intersection calculation (i.e. the calculated intersection), the interference coordinating apparatus 100 may generate the ABS pattern assigned to the one of the at least one pico cell that interfering by the plurality of macro cells.

In some embodiments, the method for coordinating inter-cell interference further comprises that when the first ABS patterns do not have the calculated intersection, according to the interference strength of each macro cell, the interference coordinating apparatus 100 may use the coordinator to determine which one of the first ABS patterns to adopt to generate the ABS pattern assigned to the one of the at least one pico cell that interfering by a plurality of macro cells. In some embodiments, according to the first ABS pattern which is provided by one of the plurality of macro cells with the greatest interference strength, the interference coordinating apparatus 100 may use the coordinator to determine to generate the ABS pattern assigned to the one of the at least one pico cell that interfering by the plurality of macro cells.

In some embodiments, the method for coordinating inter-cell interference further comprises that according to the first ABS pattern provided by each macro cell, the interference coordinating apparatus 100 may use the coordinator to generate a second ABS pattern assigned to each of the at least one femto cell to reduce the interference on each macro cell that interfering by the at least one femto cell.

In some embodiments, the method for coordinating inter-cell interference further comprises that the interference coordinating apparatus 100 may establish a link between at least one femto cell and the second virtual cell through a fourth interface each corresponding to each femto cell to receive and transmit data.

In some embodiments, the method for coordinating inter-cell interference further comprises that, according to the second ABS pattern of each of the at least one femto cell, the interference coordinating apparatus 100 may use the coordinator to generate the ABS pattern assigned to each macro cell that interfering by the at least one femto cell. Further, the interference coordinating apparatus 100 may use the coordinator to transmit the second ABS patterns to the second virtual cell. The interference coordinating apparatus 100 may use the second virtual cell to transmit the second ABS patterns to at least one femto cell through each fourth interface corresponding to each femto cell. In addition, the interference coordinating apparatus 100 may use the second virtual cell to transmit the ABS pattern assigned to each macro cell to each macro cell.

In some embodiments, the method for coordinating inter-cell interference further comprises that the interference coordinating apparatus 100 may use the coordinator to perform a complementary calculation on the first ABS pattern to generate the second ABS pattern of at least one femto cell.

In some embodiments, the method for coordinating inter-cell interference further comprises that, when one of the at least one femto cell interferes with a plurality of macro cells, the interference coordinating apparatus 100 may use the coordinator to perform a union calculation on the first ABS patterns provided by the plurality of macro cells, and then perform a complementary calculation on result of the union calculation to generate the second ABS pattern assigned to the one of the at least one femto cell which interferes with the macro cells.

According to an embodiment of the disclosure, the interference coordinating apparatus 100 may execute a computer program product stored in a non-volatile computer readable media to perform the method for coordinating inter-cell interference provided in the embodiments of the disclosure.

According to the interference coordinating apparatus and the method for coordinating inter-cell interference provided in the embodiments of the disclosure, the coordination and the assignment of the ABS patterns for the macro cell which has two different roles (i.e. victim cell and aggressor cell) may be realized in an interference coordinating apparatus to reduce the conflict between the ABS pattern assigned to the victim cell and the ABS pattern assigned to the aggressor cell. In addition, the interference coordinating apparatus and the method for coordinating inter-cell interference provided in the embodiments of the disclosure can be applied to the cover ranges of a plurality of macro cells.

Use of ordinal terms such as “first”, “second”, “third”, etc., in the disclosure and claims is for description. It does not by itself connote any order or relationship.

The method and algorithm disclosed herein may be executed directly by at least one processor which is configured to the call processing device to apply in hardware, in a software module or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor could read information (e.g., code) from the storage medium and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some embodiments any suitable computer-program product may include a computer-readable medium comprising codes relating to one or more of the embodiments of the disclosure. In some embodiments a computer program product may include packaging materials.

The above paragraphs describe many aspects. Accordingly, the teaching of the disclosure may be accomplished by many methods, and any configurations or functions in the disclosed embodiments only present a representative condition. Those who are skilled in this technology will understand that all of the disclosed aspects in the disclosure may be applied independently or be incorporated.

While the disclosure has been described by way of example and as exemplary embodiments only, it should be understood that the disclosure is not configured to limit thereto. Those who are skilled in this technology can still make various alterations and modifications without departing from the scope and spirit of this disclosure. Therefore, the scope of the invention shall be defined and protected by the following claims and their equivalents.

What is claimed is:

1. An interference coordinating apparatus, comprising:
a processor, operating a first virtual cell to simulate a victim cell, and operating a second virtual cell to simulate an aggressor cell; and
a transceiver, coupled to the processor,
wherein the processor controls the transceiver to establish a link between at least one macro cell and the first virtual cell through a first interface each corresponding to each of the at least one macro cell, and establish a link between the at least one macro cell and the second virtual cell through a second interface each corresponding to each of the at least one macro cell to receive and transmit data, and
wherein the processor operates a coordinator to receive a first ABS pattern provided by each of the at least one macro cell to reduce interference on at least one pico cell that interfering by each of the at least one macro cell and reduce interference on each of the at least one macro cell that interfering by at least one femto cell.

2. The interference coordinating apparatus of claim 1, wherein the processor controls the transceiver to establish a link between the at least one pico cell and the first virtual cell through a third interface each corresponding to each pico cell to receive and transmit data, wherein according to the first ABS pattern provided by each macro cell, the coordinator generates an ABS pattern assigned to each pico cell that interfering by the at least one macro cell, and the first virtual cell transmits the ABS pattern assigned to each pico cell to each of the at least one pico cell through the third interface corresponding to each pico cell.

3. The interference coordinating apparatus of claim 2, wherein when one of the at least one pico cell experiences interference from a plurality of macro cells, the coordinator performs an intersection calculation on first ABS patterns provided by each of the plurality of macro cells, and when the first ABS patterns have a calculated intersection, according to result of the intersection calculation, the coordinator generates the ABS pattern assigned to the one of the at least one pico cell.

4. The interference coordinating apparatus of claim 3, wherein when the first ABS patterns do not have the calculated intersection, according to an interference strength of each of the plurality of macro cells, the coordinator determines which one of the first ABS patterns to adopt to generate the ABS pattern assigned to the one of the at least one pico cell.

5. The interference coordinating apparatus of claim 4, wherein according to the first ABS pattern which is provided by one of the plurality of macro cells with the greatest interference strength, the coordinator determines to generate the ABS pattern assigned to the one of the at least one pico cell.

6. The interference coordinating apparatus of claim 1, wherein according to the first ABS pattern provided by each macro cell, the coordinator generates a second ABS pattern assigned to each of the at least one femto cell to reduce interference on each of the at least one macro cell that interfering by the at least one femto cell.

7. The interference coordinating apparatus of claim 6, wherein the processor controls the transceiver to establish a link between the at least one femto cell and the second virtual cell through a fourth interface each corresponding to each femto cell to receive and transmit data.

8. The interference coordinating apparatus of claim 7, wherein according to the second ABS pattern, the coordinator generates an ABS pattern assigned to each of the at least one macro cell that interfering by the at least one femto cell, wherein the coordinator transmits the second ABS pattern to the second virtual cell, and wherein the second virtual cell transmits the second ABS pattern assigned to each of the at least one femto cell to the at least one femto cell through the fourth interface each corresponding to each femto cell, and the second virtual cell transmits the ABS pattern assigned to each of the at least one macro cell to the at least one macro cell through the second interface each corresponding to each of the at least one macro cell.

9. The interference coordinating apparatus of claim 6, wherein when the at least one femto cell interferes with one of the at least one macro cell, the coordinator performs a complementary calculation on the first ABS pattern provided by the one of the at least one macro cell to generate the second ABS pattern of each of the at least one femto cell.

10. The interference coordinating apparatus of claim 6, wherein when one of the at least one femto cell interferes with a plurality of macro cells, the coordinator performs a union calculation on first ABS patterns provided by the plurality of macro cells, and performs a complementary calculation on result of the union calculation to generate the second ABS pattern assigned to the one of the at least one femto cell.

11. A method for coordinating inter-cell interference, applied to an interference coordinating apparatus, comprising:
establishing a link between at least one macro cell and a first virtual cell of the interference coordinating apparatus through a first interface each corresponding to each of the at least one macro cell, wherein the first virtual cell is configured to simulate a victim cell;
establishing a link between the at least one macro cell and a second virtual cell of the interference coordinating apparatus through a second interface each corresponding to each of the at least one macro cell to receive and transmit data, wherein the second virtual cell is configured to simulate an aggressor cell; and
operating a coordinator of the interference coordinating apparatus to receive a first ABS pattern provided by each of the at least one macro cell to reduce interference on at least one pico cell that interfering by each of the at least one macro cell and reduce interference on each of the at least one macro cell that interfering by at least one femto cell.

12. The method for coordinating inter-cell interference of claim 11, further comprising:
establishing a link between the at least one pico cell and the first virtual cell through a third interface each corresponding to each of the at least one pico cell to receive and transmit data;
according to the first ABS pattern provided by each macro cell, operating the coordinator to generate an ABS pattern assigned to each pico cell that interfering by the at least one macro cell; and
operating the first virtual cell to transmit the ABS pattern assigned to each pico cell to each of the at least one pico cell through the third interface each corresponding to each of the at least one pico cell.

13. The method for coordinating inter-cell interference of claim 12, further comprising:
when one of the at least one pico cell experiences interference from a plurality of macro cells, operating the coordinator to perform an intersection calculation on first ABS patterns provided by each of the plurality of macro cells, and when the first ABS patterns have a calculated intersection, according to result of the intersection calculation, generating the ABS pattern assigned to the one of the at least one pico cell.

14. The method for coordinating inter-cell interference of claim 13, further comprising:
when the first ABS patterns do not have the calculated intersection, according to an interference strength of each of the plurality of macro cells, operating the coordinator to determine which one of the first ABS patterns to adopt to generate the ABS pattern assigned to the one of the at least one pico cell.

15. The method for coordinating inter-cell interference of claim 14, further comprising:
according to the first ABS pattern provided by one of the plurality of macro cells with the greatest interference strength, operating the coordinator to determine to generate the ABS pattern assigned to the one of the at least one pico cell.

16. The method for coordinating inter-cell interference of claim 11, further comprising:
according to the first ABS pattern provided by each macro cell, operating the coordinator to generate a second ABS pattern assigned to each of the at least one femto cell to reduce interference on each of the at least one macro cell that interfering by the at least one femto cell.

17. The method for coordinating inter-cell interference of claim 16, further comprising:
establishing a link between the at least one femto cell and the second virtual cell through a fourth interface each corresponding to each of the at least one femto cell to receive and transmit data.

18. The method for coordinating inter-cell interference of claim 17, further comprising:
according to the second ABS pattern, operating the coordinator to generate an ABS pattern assigned to each of the at least one macro cell that interfering by the at least one femto cell;
operating the coordinator to transmit the second ABS pattern to the second virtual cell;
operating the second virtual cell to transmit the second ABS pattern assigned to each of the at least one femto cell to the at least one femto cell through the fourth interface each corresponding to each of the at least one femto cell; and
transmitting the ABS pattern assigned to each of the at least one macro cell to the at least one macro cell through the second interface each corresponding to each of the at least one macro cell.

19. The method for coordinating inter-cell interference of claim 16, further comprising:
when the at least one femto cell interferes with one of the at least one macro cell, operating the coordinator to perform a complementary calculation on the first ABS pattern provided by the one of the at least one macro cell to generate the second ABS pattern of each of the at least one femto cell.

20. The method for coordinating inter-cell interference of claim 16, further comprising:
when one of the at least one femto cell interferes with a plurality of macro cells, operating the coordinator to perform a union calculation on first ABS patterns provided by the plurality of macro cells, and perform a complementary calculation on result of the union calculation to generate the second ABS pattern assigned to the one of the at least one femto cell.

21. A non-volatile computer-readable media storing a computer program product, configured to perform:
establishing a link between at least one macro cell and a first virtual cell of an interference coordinating apparatus through a first interface each corresponding to each of the at least one macro cell, wherein the first virtual cell is configured to simulate a victim cell;
establishing a link between the at least one macro cell and a second virtual cell of the interference coordinating apparatus through a second interface each corresponding to each of the at least one macro cell to receive and transmit data, wherein the second virtual cell is configured to simulate an aggressor cell; and
operating a coordinator of the interference coordinating apparatus to receive a first ABS pattern provided by each of the at least one macro cell to reduce interference on at least one pico cell that interfering by each of the at least one macro cell and reduce interference on each of the at least one macro cell that interfering by at least one femto cell.

22. The non-volatile computer-readable media of claim 21, wherein the computer program product is further configured to perform:
establishing a link between the at least one pico cell and the first virtual cell through a third interface each corresponding to each of the at least one pico cell to receive and transmit data;
according to the first ABS pattern provided by each macro cell, operating the coordinator to generate an ABS pattern assigned to each pico cell that interfering by the at least one macro cell; and
operating the first virtual cell to transmit the ABS pattern assigned to each pico cell to each of the at least one pico cell through the third interface each corresponding to each of the at least one pico cell.

23. The non-volatile computer-readable media of claim 22, wherein the computer program product is further configured to perform:
when one of the at least one pico cell experiences interference from a plurality of macro cells, operating the coordinator to perform an intersection calculation on first ABS patterns provided by each of the plurality of macro cells, and when the first ABS patterns have a calculated intersection, according to result of the intersection calculation, generating the ABS pattern assigned to the one of the at least one pico cell.

24. The non-volatile computer-readable media of claim 23, wherein the computer program product is further configured to perform:
when the first ABS patterns do not have the calculated intersection, according to an interference strength of each of the plurality of macro cells, operating the coordinator to determine which one of the first ABS patterns to adopt to generate the ABS pattern assigned to the one of the at least one pico cell.

25. The non-volatile computer-readable media of claim 24, wherein the computer program product is further configured to perform:
according to the first ABS pattern which is provided by one of the plurality of macro cells with the greatest interference strength, operating the coordinator to determine to generate the ABS pattern assigned to the one of the at least one pico cell.

26. The non-volatile computer-readable media of claim 21, wherein the computer program product is further configured to perform:
according to the first ABS pattern provided by each macro cell, operating the coordinator to generate a second ABS pattern assigned to each of the at least one femto cell to reduce interference on each of the at least one macro cell that interfering by the at least one femto cell.

27. The non-volatile computer-readable media of claim 26, wherein the computer program product is further configured to perform:
establishing a link between the at least one femto cell and the second virtual cell through a fourth interface each corresponding to each of the at least one femto cell to receive and transmit data.

28. The non-volatile computer-readable media of claim 27, wherein the computer program product is further configured to perform:
according to the second ABS pattern, operating the coordinator to generate an ABS pattern assigned to each macro cell that interfering by the at least one femto cell;
operating the coordinator to transmit the second ABS pattern to the second virtual cell;
operating the second virtual cell to transmit the second ABS pattern assigned to each of the at least one femto cell to the at least one femto cell through the fourth interface each corresponding to each of the at least one femto cell; and
transmitting the ABS pattern assigned to each of the at least one macro cell to the at least one macro cell through the second interface each corresponding to each of the at least one macro cell.

29. The non-volatile computer-readable media of claim 26, wherein the computer program product is further configured to perform:
when the at least one femto cell interferes with one of the at least one macro cell, operating the coordinator to perform a complementary calculation on the first ABS pattern provided by the one of the at least one macro cell to generate the second ABS pattern of each of the at least one femto cell.

30. The non-volatile computer-readable media of claim 26, wherein the computer program product is further configured to perform:
when one of the at least one femto cell interferes with a plurality of macro cells, operating the coordinator to perform a union calculation on the first ABS patterns provided by the plurality of macro cells, and perform a complementary calculation on result of the union calculation to generate the second ABS pattern assigned to the one of the at least one femto cell.
